(19) United States
(12) Patent Application Publication
(10) Pub. No.: US 2006/0007197 A1
(43) Pub. Date: Jan. 12, 2006

(54) Apparatus and method for light signal processing utilizing independent timing signal

(76) Inventor: John D. Gilbert, Applegate, OR (US)

Correspondence Address: INTEL CORPORATION, P.O. BOX 5326, SANTA CLARA, CA, 95056-5326, US

(21) Appl. No.: 10/880,146

(22) Filed: Jun. 29, 2004

(51) Int. Cl. G09G 5/00

(52) U.S. Cl. 345/204

(57) ABSTRACT

In some embodiments, a light processing system includes a light modulator and a controller configured to control outputting data to the light modulator in accordance with an external timing signal. The external timing signal may come from a color switching device. For example, in some embodiments, frame synchronization for a projection display is performed by a data flow controller instead the color wheel controller. In some embodiments, frames may be repeated or dropped. Other embodiments are disclosed and claimed.

The invention relates to light signal processing and more particularly to controllers for projections display systems, and methods related thereto.

### BACKGROUND AND RELATED ART

Light modulator structures are well known in the art. Such structures includes liquid crystal displays (LCDs), light emitting diodes (LEDs), and micro-electronic mechanical systems (MEMS). LCDs may be reflective or transmissive. Crystalline silicon may be used to manufacture liquid crystal on silicon (LCOS) displays.

Projection displays is one of the fastest growing areas in the display industry. Industry analysts report that about 2.4 million rear projection units were sold in 2001. This number is expected to grow significantly in the future. There are a number of key technologies competing for the rear projection display market share.

Cathode ray tube (CRT) based projectors while still being the mainstream technology facing an extremely difficult challenge to meet requirements of today's high performance systems. The systems are heavy and not portable and brightness is generally limited to fewer than 300 ANSI lumens.

A fast growing area of projection displays market is represented by poly-silicon based LCD projection systems. By producing better TFT transistors with higher temperature processes, this technology allows integration of the row and column drivers right into the quartz substrate, thus decreasing cost and increasing the aperture ratio. However, increasing yield for larger size panels remains a challenge for this approach.

Micro mirror devices are also used in a variety of rear projection systems. They operate by controlling the direction of reflected light on per pixel basis. These systems are known to achieve good contrast and brightness levels.

Recently, attention has been directed to building liquid crystal on silicon (LCOS) based projection displays. These displays essentially operate by electronically controlling a thin layer of liquid crystal (LC) material encapsulated between two substrates. For example, the two substrates include a transparent substrate (e.g. glass) and a reflective substrate (e.g. planarized and mirrored silicon substrate). There are several benefits to the use of reflective LCOS devices. The optical advantage is an increase of the effective aperture ratio because various control electronics can be hidden under the mirrored pixel structure. Electrically, the performance of the driver circuitry is very high because it is manufactured on a well known and proven CMOS process, which also leads to highly reliable and cost effective solutions.

### BRIEF DESCRIPTION OF THE DRAWINGS

Various features of the invention will be apparent from the following description of preferred embodiments as illustrated in the accompanying drawings, in which like reference numerals generally refer to the same parts throughout the drawings. The drawings are not necessarily to scale, the emphasis instead being placed upon illustrating the principles of the invention.

FIG. 1 is a top, schematic view of a spatial light modulator device, suitable for implementing some embodiments of the present invention.

FIG. 2 is a perspective view of a display system, suitable for implementing some embodiments of the present invention.

FIG. 3 is a block level schematic diagram of an image processing system, suitable for implementing some embodiments of the present invention.

FIG. 4 is a block level schematic diagram of a controller according to some embodiments of the invention.

FIG. 5 is a block level schematic diagram of another controller according to some embodiments of the invention.

FIG. 6 is a state diagram for a three panel system according to some embodiments of the invention.

FIG. 7 is a state diagram for a two panel system according to some embodiments of the invention.

FIG. 8 is a block level schematic diagram of a controller having an external timing signal, according to some embodiments of the invention.

FIG. 9 is a block level diagram of another controller having an external timing signal according to some embodiments of the invention.

FIG. 10 is a flow diagram according to some embodiments of the invention.

FIG. 11 is another flow diagram according to some embodiments of the invention.

FIG. 12 is a schematic diagram of a buffer management technique according to some embodiments of the invention.

FIG. 13 is another schematic diagram of a buffer management technique according to some embodiments of the invention.

FIG. 14 is another schematic diagram of a buffer management technique according to some embodiments of the invention.

### DESCRIPTION

In the following description, for purposes of explanation and not limitation, specific details are set forth such as particular structures, architectures, interfaces, techniques, etc. in order to provide a thorough understanding of the various aspects of the invention. However, it will be apparent to those skilled in the art having the benefit of the present disclosure that the various aspects of the invention may be practiced in other examples that depart from these specific details. In certain instances, descriptions of well known devices, circuits, and methods are omitted so as not to obscure the description of the present invention with unnecessary detail.

Further description of various components and methods of operation may be had with reference to co-pending application with Ser. No. 10/______, filed on even date herewith and entitled APPARATUS AND METHOD FOR LIGHT SIGNAL PROCESSING UTILIZING SUB-FRAME SWITCHING, and/or co-pending application with Ser. No. 10/______, filed on even date herewith and entitled APPARATUS AND METHOD FOR LIGHT SIGNAL PROCESSING UTILIZING DECOUPLED INPUT AND OUTPUT TIMING.

With reference to FIG. 1, an example light modulator 10 comprises a liquid crystal on silicon (LCOS) device having a silicon substrate 11 and a cover glass 12 covering a pixel area 13 made up of pixel elements (not shown). Liquid crystal material is disposed between the cover glass 12 and the substrate 11. The cover glass 12 is secured to the substrate 11 by an adhesive strip 16. The adhesive strip 16 defines an enclosed perimeter which seals the liquid crystal material inside the area of the adhesive strip 16 under the cover glass 12. For example, the adhesive strip 16 is a bead of epoxy. The light modulator 10 may include an area on the substrate 11 outside of the area of the cover glass 12 (e.g. outside the area of the adhesive strip 16) which includes additional circuitry 18. According to some embodiments of the present invention, the additional circuitry 18 may be utilized to implement all or some of the novel circuits or methods described herein.

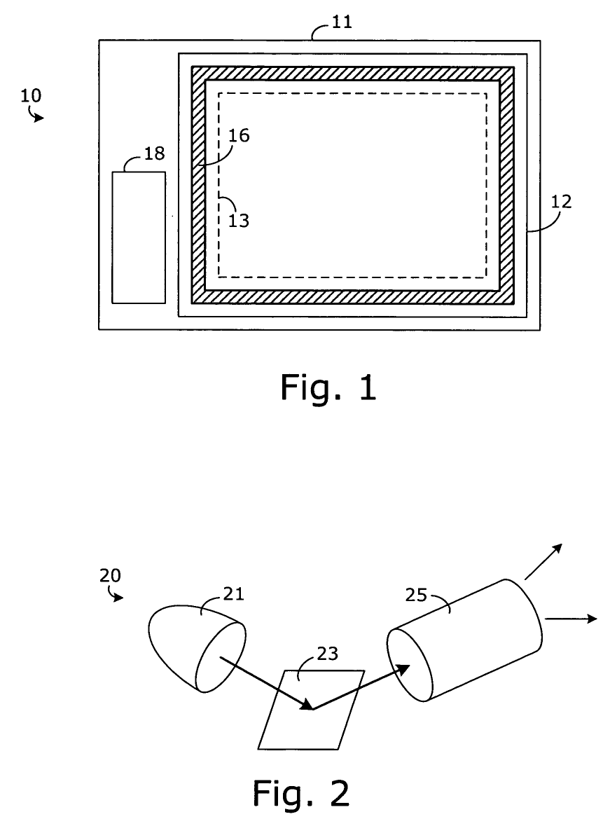

With reference to FIG. 2, a display system 20 according to some embodiments of the invention includes a light engine 21, a light modulator 23 receiving light from the light engine and encoding the light with image information, and a projection lens 25 receiving the encoded light from the light modulator 23 and projecting the encoded light. For example, the light modulator 23 may comprise an LCOS device. Alternatively, the light modulator may comprise any other now known or hereinafter discovered light modulator device capable of encoding light with image or data information, including, for example, a micro-electronic mechanical system (MEMS) device such as a micro-mirror device. In some embodiments, the light modulator 23 includes a die with circuitry disposed on the die that may be utilized to implement all or some of the novel circuits or methods described herein. In some embodiments, the die may incorporate other video data processing algorithms in a single integrated circuit chip. In other embodiments, some or all of the novel circuits or methods described herein may be implemented separately from the light modulator 23 but are otherwise incorporated in the system 20.

In a conventional projection system, the light engine may include a light source which produces what is considered to be white light. The light engine may further include a color switching device, for example a color wheel, which may be utilized to filter the white light and output different colors (e.g. red, green, and blue (RGB), or cyan, magenta, and yellow (CMY)). Another non-limiting example of a color switching device includes shutters.

For systems utilizing a color wheel, the color wheel may be a flat disc divided into radial or spiral sections. The disc is mounted on a DC motor which rotates the disc at a desired rate, which is typically about 60 Hz. The disc may include a timing mark which may be read by a sensor, with the sensor output utilized as feedback to adjust the DC motor and keep the disc rotating at the desired rate. In many conventional systems, the output of frame data is derived from the input video signal and is attempted to be synchronized with the nominal frame rate (e.g. 60 Hz). However, a problem inherent with such mechanical color switching systems is that the system is subject to vibration, jitter, tolerances, or other mechanical issues which affect the stability of the switching (e.g. variations in the rotational rate of the color wheel). A further problem is that the ability to control the mechanical aspects of the system is subject to the relatively slow mechanical response time of the components. For example, in a color wheel system, if the motor is rotating too slow or too fast, the inertia of the spinning disc takes an appreciable amount of time to either accelerate or decelerate.

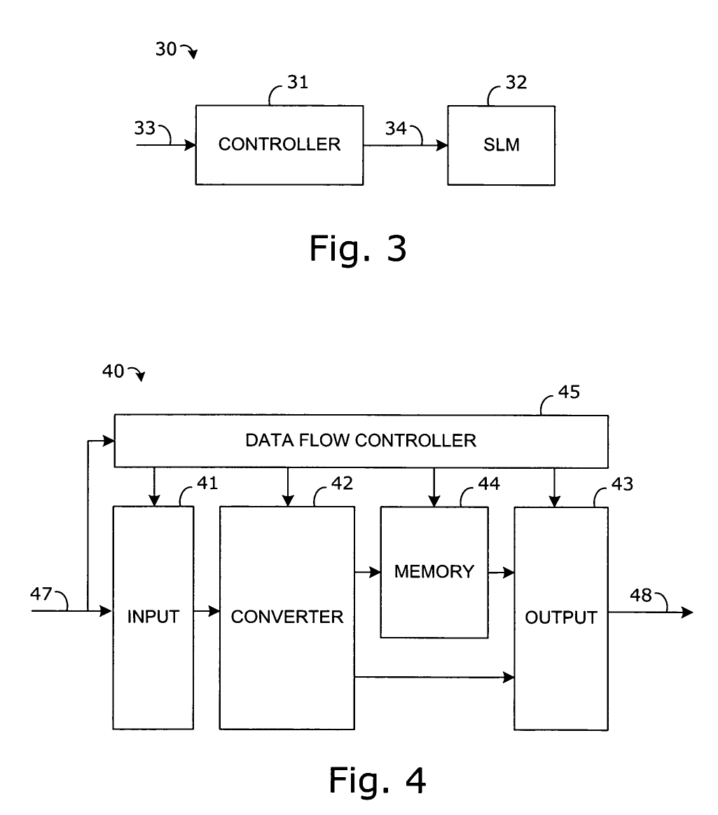

With reference to FIG. 3, a light processing system 30 includes a controller 31 coupled to a light modulator 32, which may be, for example, a spatial light modulator (SLM). The controller 31 receives an input signal 33 and provides an output signal 34 to the SLM 32. A preferred application for the system includes a projection display system. Other non-limiting examples for applications which may beneficially utilize the light processing system 30 include optical communication systems wherein light is encoded and transmitted (e.g. via fiber optics) and subsequently received and decoded (e.g. via a charge coupled device (CCD)). Optical busses connected between computer systems and optical busses coupled between integrated circuits mounted on the same circuit board may also beneficially utilize the system 30. In many applications, the image or data information needs to be processed in order to be appropriately encoded by the light modulator. For example, image data may need to separated into various color components and sequentially encoded at a desired timing for display. Data information may need to be broken into packets for transmission. Other processing may also be beneficial, depending on the application.

For example, the input signal 33 may be provided from any of a number of input sources, including still cameras, video camera, and/or pre-recorded sources such as video compact discs (VCDs) or digital video discs (DVDs). The input signal may correspond to image data and/or other digital data for transmission through the light processing system 30. The input signal 33 may directly originate from such sources or may be pre-processed and/or otherwise stored and provided from a storage device such as a hard disk drive, a flash drive, a removable memory card, system memory or other system storage.

According to some embodiments of the invention, the controller 31 receives the input signal 33 and processes the signal 33 to provide an appropriate output signal 34 for the SLM 32, examples of which are described in detail below. For example, the input signal 33 may include an independent timing signal and the controller may process the image data in accordance with the independent timing signal. For example, the independent timing signal may be provided by an external color switching device (such as a color wheel). In some embodiments, the controller 31 synchronizes image data (e.g. RGB video data) sent to one or more LCOS panels 32 in accordance with a timing signal derived from a color wheel. Advantageously, for some embodiments of the invention, utilizing the independent timing signal may alleviate certain mechanical timing constraints and/or simplify timing coordination for the image data within the light processing system.

For example, in a system utilizing a color wheel the controller 31 may receive the sensor output as a periodic signal corresponding to the timing mark. The controller 31 may control the output of frame or sub-frame data to the SLM 32 in accordance with the external timing signal. The controller 31 and SLM 32 are both electronic integrated circuits which can be controlled much faster and more accurately than the relatively slow mechanical color switching system. Accordingly, some embodiments of the invention may advantageously change the burden of color synchronization from the color switching equipment to the data flow controller, which in turn may reduce color switching complexity and cost in video projection equipment.

It is noted that the mechanical system preferably may still include its own control and feedback system (or such control may be incorporated in the controller 31) to keep the switching device operating at a desired rate. The faster electronic control of some embodiments of the invention may complement the mechanical control to keep the frame output synchronized with the switching device at substantially all times, including a period of adjustment of the mechanical device which may include undershoot or overshoot of the mechanical control system.

With reference to FIG. 4, a controller 40, according to some embodiments of the invention, for a light processing system includes an input portion 41 coupled to a converter 42. The converter 42 is coupled to an output portion 43. A memory portion 44 is coupled between the converter 42 and the output portion 43. A data flow controller 45 provides control signals to each of the input portion 41, the converter 42, the memory portion 43, and the output portion 44. In this example the data flow controller 45 is shown as not receiving signals from the other portions, but in some applications the various portions may provide signals to the data flow controller 45, e.g. for use by the data flow controller 45 in performing its control operations. Input signal(s) 47 are provided to the input portion 41 and the data flow controller 45. The output portion provides output signal(s) 48. The converter portion 42 receives data from the input portion and converts it to a suitable format for output.

In general terms, the controller 40 operates as follows. The controller 40 receives input signals 47 at the input portion 41. The data flow controller 45 controls the flow of data from the input portion 41, through the converter 42, and through the output portion 43 as output signals 48, utilizing the memory portion 44 as may be necessary or desirable. For example, the data flow controller may implement an algorithm which maintains data timing integrity between the input and output data streams. Advantageously, according to some embodiments of the invention, formatted input and output streams may be managed from separate clocking domains. The memory portion 44 may include substantial storage capacity and/or may include an interface to additional storage capacity external to the controller 40. The memory portion 44 may be utilized to implement a data buffering algorithm as may be necessary or desirable for buffering the output data.

For example, the controller 40 may accept formatted video image data, and convert it for display. In some applications, the display output may be provided for up to three LCOS panel interfaces, for example one each for Red, Green, and Blue data. In a two panel system, the display output may provide one interface for Red data and another for Blue and Green data. The controller 40 may provide synchronization and data conversion to adjust the input video data to display correctly on the LCOS panels.

For example, the controller 40 may be implemented on the LCOS device or as a separate single chip implementation. The controller 40 may be implemented on a field programmable gate array (FPGA) or as an application specific integrated circuit (ASIC). Of course, other implementations are possible including discrete circuitry on a printed circuit board, and various portions of the controller may be implemented on different chips and/or boards. For example, while the novel architecture described herein may be constructed to be flexible and expandable, not all features may be implemented within a specific FPGA, due to speed, pin, or code size constraints.

In some embodiments, the input portion 41 may be adapted to receive input signals 47 including a standard CMOS level digital bus, with the data separated into Red, Green, and Blue channels. The input signal may further include standard vertical sync, horizontal sync, data enable, and pixel clock signals. According to some embodiments, the input portion 41 may be configured to determine pixel, line, and frame characteristics, separate the data into dedicated red, green, and blue FIFO streams, tags pixels of interest for later processing (for example, ‘end of frame’, ‘start of line’, etc.), and, depending on mode, strip blanking information.

A preferred input format includes progressive format (non-interlaced) video data. In some embodiments, data provided from the input portion 41 to the converter portion 42 is processed and converted from a standard progressive RGB format to another format appropriate for driving the light modulator panel(s). For example, the data flow controller portion 45 may control image and/or data information flow to up to three light modulator panel display outputs. For example, the output portion may output image and/or data information encoded on nine Low Voltage Differential Signaling (LVDS) pairs (8 data, 1 clock) per panel.

In some applications, a resolution of the input image data may already correspond to resolution of the light modulator panel(s) (e.g. 1280×768×60 Hz), or a subset thereof. Alternatively, the input image data may be pre-processed to scale the image data or the controller 40 may include a scaling portion to modify the resolution of the input image data to correspond to the resolution of the display panel(s). In some examples, configuration of and/or communication with the controller 40 may be performed via a set of registers in the input portion 41 and/or data flow controller 45, which may be accessed through an industry standard interface such as, for example, the Inter-Integrated Circuit (I²C) interface.

Depending on the particular application, the controller 40 can output pixel data simultaneously to all panels (e.g. in a three panel unbuffered pass-through implementation), or as one, two, or three color sub-frames per frame to any given panel (sequentially, for example, Blue/Green on one panel in a two panel implementation). In some applications, the memory portion 44 may include a frame storage memory interface including a memory controller used to manipulate a frame buffer storage algorithm (e.g. utilizing external double data rate synchronous dynamic random access memory—DDR SDRAM). Formatted input and output frames may be managed from separate clocking domains. The data flow controller 45 may implement a flow control algorithm designed to maintain data timing integrity between the input and output video data streams.

In some embodiments, the input signals 47 may include an independent timing signal provided to the data flow controller 45, and the controller 45 may process the image data in accordance with the independent timing signal. For example, the independent timing signal may be provided by an external color switching device (such as a color wheel), as described in detail above, and the controller 45 may control the output of data from the output portion 43 in accordance with the independent timing signal. Advantageously, for some embodiments of the invention, utilizing the independent timing signal may alleviate certain mechanical timing constraints and/or simplify timing coordination for the image data within the light processing system.

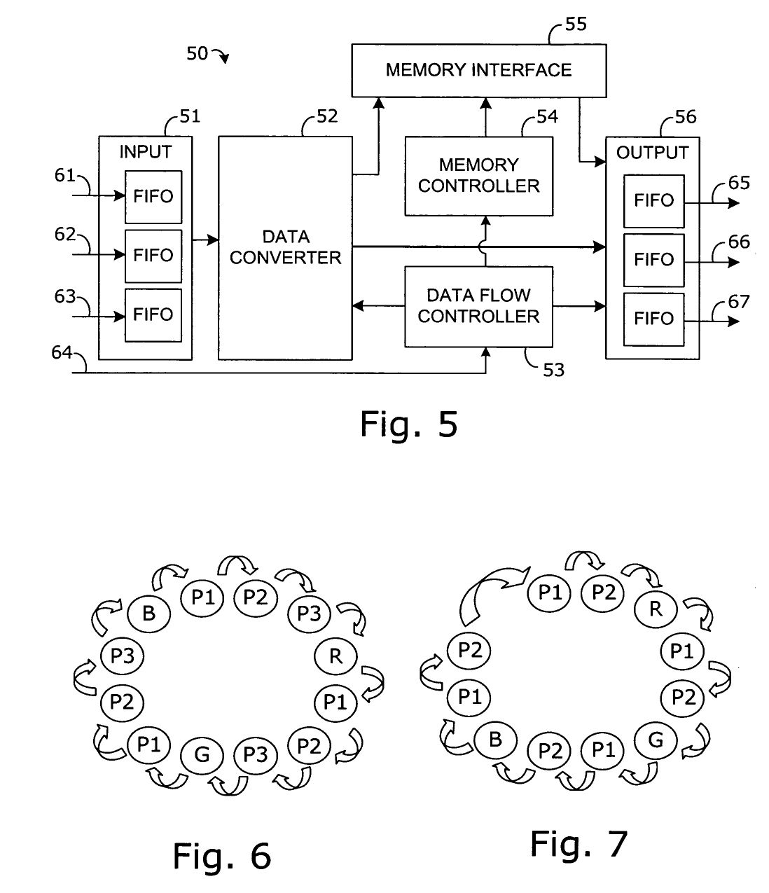

With reference to FIG. 5, a controller 50, according to some embodiments of the invention, for a light processing system includes an input portion 51 coupled to a data converter 52. The input portion 51 includes a plurality of first-in first-out (FIFO) circuits, with each FIFO receiving respective input streams 61, 62, and 63. The data converter 52 is coupled to an output portion 56. The output portion 56 includes a plurality of first-in first-out (FIFO) circuits, with each FIFO providing respective output streams 65, 66, and 67). A memory interface 55 is coupled between the data converter 52 and the output portion 56. A data flow controller 53 receives an input signal 64 and provides control signals to each of the data converter 52 and the output portion 56, and also to a memory controller 54 which is connected to the memory interface 55.

In general terms, the controller 50 operates as follows. The controller 50 receives input signals 61, 62, and 63 at the input portion 51. The data flow controller 53 receives the input signal 64 and controls the flow of data from the input portion 51, through the converter 52, and through the output portion 56 as output signals 65, 66, and 67, utilizing the memory controller 54 as may be necessary or desirable. The memory controller 54 controls the memory interface 55, which may include substantial storage capacity and/or may include an interface to additional storage capacity external to the controller 50.

In some embodiments, the input signal 64 may include an independent timing signal provided to the data flow controller 53, and the controller 53 may process the image data in accordance with the independent timing signal. For example, the independent timing signal may be provided by an external color switching device (such as a color wheel), as described in detail above, and the controller 53 may control the output of data from the output portion 56 in accordance with the independent timing signal. Advantageously, for some embodiments of the invention, utilizing the independent timing signal may alleviate certain mechanical timing constraints and/or simplify timing coordination for the image data within the light processing system.

In some applications, the controller 50 may be configured to provide buffered video data flow. For example, buffered video data flow may be utilized for single or two panel light processing systems, such as projection displays. Even for three or more panel light processing systems, buffered video data flow may be useful for applications utilizing an independent external frame synchronization signal, or where a fixed output pixel clock is desired—e.g. differing from the input pixel clock rate. In most applications, buffered video data flow benefits from a substantial amount of storage capacity, which may include external memory accessed, for example, through the memory interface 55.

In some embodiments of buffered video data flow, the input video data stream is buffered in memory on a frame-by-frame basis. Each color's data may be separated, essentially partitioning a frame of video into three color sub-frames. The output video data stream may lag the input stream by one frame. As one frame or sub-frame is being output from memory 55 to the output 56 (e.g. the panel interface), another frame or sub-frame is being simultaneously loaded from the input 51. Output sub-frame data may be streamed at a higher rate that the input frame rate (e.g. five times the rate of input frames), with longer blanking periods in between.

To achieve a co-ordination of frame timing, the input portion 51 may be enabled for valid pixel data only (i.e. the input side may be gated by an input data enable signal). This pixel data may then be run through the data converter 52, and then placed in memory through the memory interface 55, in full frame format, ready for output. Similarly, the output portion 56 may be enabled for valid data only. This causes the automatic insertion of the correct blanking information to the data stream. Output data may be retrieved from the memory interface one frame or sub-frame at a time, and then output.

In some embodiments, a preferred timing relationship should be maintained to promote the correct flow of data through the memory and the FIFOs. This relationship may be dependent on the input data rate, the number of output panels enabled, and the output data rate (e.g. pixel clock, or panel output clock—OCLK) to the panels. An example maximum input data rate at the output of each FIFO in the input portion 51 in buffered mode may be determined as follows. Presuming that all blanking is stripped from the pixel stream, for a 1280×768 image size at a 60 Hz frame rate, each input FIFO may receive two hundred fourteen (214) 6-pixel packets per line by 768 lines as the maximum number of 48-bit pixel data words possibly input in a frame. This resolves to about 9.86 million words/second, or, in other words, each input FIFO must be emptied at faster than an about 9.86 MHz rate. For this example a suitable servicing rate for the three input FIFOs of 9.86 MHz×3 is about 29.58 MHz, or roughly 30 MHz.

In most applications, the output FIFOs should each be filled faster than the panel output clock, since the data size may be the same at the FIFO input side and output side. Therefore, the output FIFOs should be filled at a minimum rate of OCLK×(# panels enabled).

An algorithm-independent lower bound may be determined for a desired memory clock speed. For example, the memory clock speed may correspond to a suitable rate to service all three input FIFOs, and all enabled output FIFOs. This is approximately OCLK×(# panels enabled)+input data rate (e.g. 30 MHz). For example, for a two panel configuration having a panel output clock of 52 MHz, the minimum memory clock rate is 52 MHz×2+30 MHz=134 MHz. The foregoing example assumes continuous single clock bursting of data from memory—however memory efficiency is implementation dependent, and should be factored into the actual clock rate used.

The timing relationships, coupled with the FIFO depths (all FIFOs, e.g. both the input and output FIFOs, may have the exact same depth), may be important to proper execution of the algorithm used to maintain data flow without FIFO overruns or starvation. According to some embodiments of the invention, a round robin monitoring of FIFO levels may be used to promote consistent data flow at the various interface points.

With reference to FIGS. 6 and 7, respective state diagrams illustrate different round robin monitoring techniques. In these examples, the input FIFO data may be converted into separate color sub-frames including, e.g. red R, green G, and blue B sub-frames. Initially, the input portion 51 and the output portion 56 may be disabled. In its disabled state, the output portion 56 may perform a synchronization function with the display panels, for example, by transmitting synchronization (idle) packets out the from panel interface. For example, the LCOS panel devices may recognize the idle packets as an indication to prepare to receive display data.

The controller 50 may await the end of a resynchronization cycle. At that time (e.g. at the beginning of a next frame of video input data), the controller may enable the input portion. This allows data to flow into the input FIFOs. In some embodiments, the input portion 51 may be configured to disregard and/or exclude blanking data.

The start of the cycle may be based on a received video input data vertical sync signal. An output vertical synchronization signal (from which start of frame timing may be internally derived) is determined in accordance with the start of the cycle. For example, the output vertical sync signal may be set to trigger on the falling edge of the video input data vertical sync signal. Alternatively, as described in detail below, the output vertical sync signal may be determined in accordance with an independent timing signal (e.g. from an external color switching device).

At an appropriate time (e.g. after initialization and after the end of a resynchronization cycle), a steady state data flow control process may begin. The data flow controller 53 may maintain a set of registers corresponding to frame data in memory (e.g. in which the frame storage sections are fixed). The registers may include frame-start and frame-end addresses for each color (sub-frames), and current pixel location. Advantageously, according to some embodiments of the invention, two or more copies of these registers may be manipulated independently. For example, one set of registers may correspond to display input frame management, and another set of registers may correspond to display output management.

In addition, the data flow controller may maintain configuration signals denoting a destination panel output FIFO for each color. In the event that multiple colors are to be sent to the same display output FIFO, the data streams may be prioritized sequentially as sub-frame #1, sub-frame #2, etc.

The data flow controller may monitor each FIFO's ‘full line detect’ flag, both for the input 51, and the output 56. If an input FIFO level grows to a nominal level, e.g. at or above a full line of video data, the data flow controller 53 may burst write a horizontal line of video data to memory, based on the position of the valid input sub-frame current pixel location. In some embodiments, tags for line-end, frame-end, and data may automatically be encoded into the data stream by the data converter 52.

If an output FIFO level falls below a full line of video data the data flow controller 53 may burst fill it with a horizontal line of video data from memory, based on the position of the valid output frame current pixel location. In general, this condition will only occur once there are output frames stored. Enabling of the output FIFOs generally will lag that of the input FIFOs by one frame. As noted above, in some embodiments, line-end, and frame-end, data tags may already be encoded into the data stream by the data converter 52.

With reference to FIG. 6, in order to maintain data in the FIFOs while reducing overruns or starvation, a modified round robin fill/empty algorithm as illustrated may be used. FIFOs may be checked for ‘full line detect’, and filled or emptied, in the following order:

At state R, the RED input FIFO may be at least partially emptied to memory. At each subsequent state P1, P2, and P3, while corresponding panel data is output to the panel, the corresponding output FIFO may be at least partially filled from memory. At the state G, the GREEN input FIFO may be at least partially emptied to memory. At each subsequent state P1, P2, and P3, while corresponding panel data is output to the panel, the corresponding output FIFO may be at least partially filled from memory. At the state B, the BLUE input FIFO may be at least partially emptied to memory. At each subsequent state P1, P2, and P3, while corresponding panel data is output to the panel, the corresponding output FIFO may be at least partially filled from memory. The round robin servicing of the input and output FIFOs continues the foregoing cycles during steady state operation.

As noted above, the desired timing may be dependent on the number of panels enabled. In general, the greater the number of panels, the faster the memory clock must be run. The algorithm may start from a nominal state ‘R’ at the beginning of each frame, and certain ‘Px’ states may be skipped, if the associated panel is not enabled. Depending on the application, additional restrictions may be placed on various timing relationships under this algorithm.

Each output FIFO may be filled only once every ‘N+1’ states, where ‘N’ corresponds to the number of panels enabled (the ‘+1’ state corresponds to an input FIFO fill). But each output FIFO may be emptied (e.g. at a different rate) at every state. Therefore, at each state, the output FIFO preferably empties by about 1/(N+1), or starvation may occur. For example, if three panels are enabled, each output FIFO may only empty by one-fourth (¼) at each state, or it may be emptied faster than it is filled. Accordingly, the memory clock rate (fills) should be at least about (N+1) times the output pixel clock rate (empties), not including overhead.

Conversely, each input FIFO may be emptied only once every about ‘3(N+1)’ states, where ‘N’ corresponds to the number of panels enabled (with ‘+1’ added for input FIFO fills). But each input FIFO may be filled (e.g. at a rate of about 10 MHz) at every state. Therefore, at each state, the input FIFO may be preferably only filled by about 1/(3(N+1)), or overrun may occur. For example, if three panels are enabled, each input FIFO should fill by about one twelfth ( 1/12) at each state, or it may be filled faster than it is emptied. Accordingly, the memory clock rate (empties) should be at least about 3(N+1) times the maximum input rate (fills, e.g. of about 10 MHz).

For some embodiments of a round robin algorithm, depending on output pixel clock speed and number of panels enabled, the minimum memory clock rate may be bounded by the greater of (N+1)×OCLK, or 3(N+1)×10 MHz, not including overhead. Note that these two numbers will generally not be equal, and for an efficient implementation, the memory overhead may be absorbed by that difference.

When a frame is completed, either input or output, a frame switch may occur (e.g. the input and output destination buffers may be swapped). For example, the relevant memory frame location registers may be set to the opposite frame in memory, and the current pixel location may reset to the new frame start location. The associated display FIFO interface may be disabled, and the data flow controller may wait for the vertical blanking period to end. For example, the completion of a frame may be triggered by the falling edge of the video input data vertical sync signal. In some applications, the display output vertical blanking may be automatically generated during this time, while the display input blanking is ignored, and not read into the FIFOs. In some applications, as described further below, an external frame sync option may be enabled, causing the display output vertical sync to be triggered, for example, by the falling edge of the video input data vertical sync signal.

In order to reduce potential starvation in the display output FIFOs, upon completion of the current frame a horizontal line of video data may be ‘pre-fetched’ from the following frame as soon as available. The pre-fetch will generally be essentially immediate, as the display input will have filled some of the frame. In some applications, e.g. when using a separate external sync to start the frame output, there may be the potential for a lack of fresh input data. Accordingly, the previous data may be held in the FIFOs until the new frame is started (e.g. via the display output vertical sync signal).

In most applications, the data flow controller may maintain the foregoing algorithm as the steady state, for example, until a soft reset or resynchronization is initiated, or the input pixel clock is lost.

A ‘frame’ for a display output panel interface can contain more than one color sub-frame. For example, in the case of a single or two panel implementation, the data flow algorithm may continue from the last line of one sub-frame to the first line of the next without pause. A vertical blanking packet may be automatically inserted due to the sub-frame change. Sub-frames may correspond to color changes or, in some applications, a sub-frame may repeat for the same color.

For an example two panel configuration, the memory clock rate should be the greater of (N+1)×OCLK or 3(N+1)×10 MHz, where N=2 (see the above description). For example, if a 52 MHz output pixel clock rate is used, then the minimum memory clock rate should be about 156 MHz or greater, not including overhead.

A non-limiting example of round robin timing for a two panel configuration with detailed memory fill/empty timing vs. data flow fill/empty timing is as follows. In this example, OCLK (output clock)=52 MHz, MCLK (memory clock)=156 MHz, and ICLK (input data clock)=10 MHz. If a horizontal line FIFO fill/empty is considered a 100% effect on a FIFO, then all un-serviced output display FIFOs empty 33-⅓% of a fill at each non-serviced state, and fill by 66-⅔% at each serviced state (as discussed above). The display input FIFOs fill by about 6.4% at each non-serviced state, and empty by about 93.6% at each serviced state. This leads to the following example table for one modified round robin cycle:

| Active Fill/ | | | | | |
|---|---|---|---|---|---|
| Empty | Panel #1 | Panel #2 | Red | Green | Blue |
| Panel #1 | +66.7% | −33.3% | +6.4% | +6.4% | +6.4% |
| Panel #2 | −33.3% | +66.7% | +6.4% | +6.4% | +6.4% |
| Red | −33.3% | −33.3% | −93.6% | +6.4% | +6.4% |
| Panel #1 | +66.7% | −33.3% | +6.4% | +6.4% | +6.4% |
| Panel #2 | −33.3% | +66.7% | +6.4% | +6.4% | +6.4% |
| Green | −33.3% | −33.3% | +6.4% | −93.6% | +6.4% |
| Panel #1 | +66.7% | −33.3% | +6.4% | +6.4% | +6.4% |
| Panel #2 | −33.3% | +66.7% | +6.4% | +6.4% | +6.4% |
| Blue | −33.3% | −33.3% | +6.4% | +6.4% | −93.6% |

From the above table, it can be seen that at no time does an output display FIFO lose more than about ⅔ of its last fill data before being checked again. Similarly, an input display FIFO never fills more than about 52% of a line before being checked. These values do not necessarily include margin for algorithm execution overhead. Whether overhead may be an issue is dependent on the algorithm implementation. However, in this example there may be about 48% of the input display FIFO clocking time available to absorb overhead, which should be more than sufficient for most implementations.

Advantageously, the round robin algorithms described herein may be simple to implement. Various changes to the algorithm may improve various timing relationships, without adding too much complexity. For example, depending on the particular implementation (e.g. for some FPGAs), 156 MHz may be too fast to run the memory clock. With slight modifications to the round robin and output display FIFOs, an algorithm for a two panel example may allow the memory clock to be about 2.75 times the OCLK, or about 143 MHz. In this example algorithm, the output display FIFOs may be increased to about 2.5 lines of data in length, and the ‘fill’ mark on the input side may be set at about 1.5 lines of data.

With reference to FIG. 7, the FIFOs may be checked for ‘full line detect’, and filled or emptied, in the following order:

At state R, the RED input FIFO may be at least partially emptied to memory. At each subsequent state P1 and P2, while corresponding panel data is output to the panel, the corresponding output FIFO may be at least partially filled from memory. At the state G, the GREEN input FIFO may be at least partially emptied to memory. At each subsequent state P1 and P2, while corresponding panel data is output to the panel, the corresponding output FIFO may be at least partially filled from memory. At the state B, the BLUE input FIFO may be at least partially emptied to memory. At each subsequent state P1 and P2, while corresponding panel data is output to the panel, the corresponding output FIFO may be at least partially filled from memory. Following the BLUE cycle, the output FIFOs are serviced for an additional cycle. The round robin servicing of the input and output FIFOs continues the foregoing cycles during steady state operation.

An example timing cycle for this modified algorithm and fill/empty table then looks as follows:

| Active Fill/ | | | | | |
|---|---|---|---|---|---|
| Empty | Panel #1 | Panel #2 | Red | Green | Blue |
| Panel #1 | +63.6% | −36.4% | +7% | +7% | +7% |
| Panel #2 | −36.4% | +63.6% | +7% | +7% | +7% |
| Red | −36.4% | −36.4% | −93% | +7% | +7% |
| Panel #1 | +63.6% | −36.4% | +7% | +7% | +7% |
| Panel #2 | −36.4% | +63.6% | +7% | +7% | +7% |
| Green | −36.4% | −36.4% | +7% | −93% | +7% |
| Panel #1 | +63.6% | −36.4% | +7% | +7% | +7% |
| Panel #2 | −36.4% | +63.6% | +7% | +7% | +7% |
| Blue | −36.4% | −36.4% | +7% | +7% | −93% |
| Panel #1 | +63.6% | −36.4% | +7% | +7% | +7% |
| Panel #2 | −36.4% | +63.6% | +7% | +7% | +7% |

Other modifications to the algorithm to improve various performance aspects may be derived on an implementation basis for specific configurations.

As noted above, in some embodiments of the invention, the display output data stream may be synchronized to an external frame synchronization signal (for example, from a color wheel or color shutter). Generally, systems utilizing the external frame synchronization may also benefit from utilizing buffered video data flow (e.g., as described above).

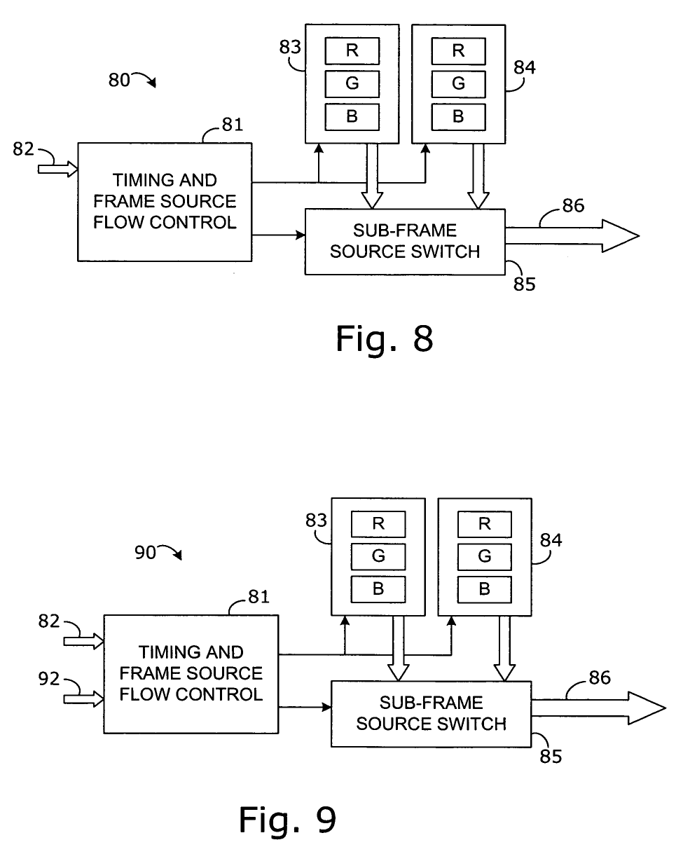

With reference to FIG. 8, a light processing system controller 80 includes a timing and frame source flow controller 81 which receives an external color switch frame timing signal 82. The flow controller 81 is coupled to and controls the flow of data into a pair of frame buffers 83 and 84, which may include separate input FIFOs for R,G, and B data. The flow controller 81 is also coupled to a sub-frame source switch 85, which receives an output from the frame buffers 83 and 84. The flow controller 81 controls the selective output of data from the switch 85 on output lines 86.

With reference to FIG. 9, a similarly configured controller 90 includes like numbered elements as described in connection with FIG. 8, and further includes an optional external color switch sub-frame timing signal 92 received by the flow controller 81. For example, a color wheel may includes two or more timing marks corresponding to different color transitions. The flow controller 81 may then be configured to synchronize the output of data to each of the sub-frames, instead of or as well as the overall frame synchronization. Advantageously, utilizing the optional sub-frame timing signal may enhance sub-frame color multiplexing capabilities in projection imagers, alleviate various mechanical timing constraints within light engine designs and/or simplify co-ordination of video data timing with color switching techniques. Moreover, as noted above, shifting the burden of color synchronization from the color switching components to the data flow components may provide better synchronization, and reduce complexity and cost.

In the following examples, instead of deriving the display output vertical sync from the display input data FIFO contents, the external frame synchronization signal becomes the display output vertical sync. Other than the vertical sync source change, the algorithm may execute substantially as described above. However, in some applications, vertical synchronization differentials may cause the input and output frame timing to drift. Advantageously, some embodiments of the present invention may repeat or drop frames to address problems with drift. Specifically, in some embodiments of the invention, the controller may repeat output video frames (or sub-frames) and/or drop input video frames (or sub-frames) to adjust to color switch timing, and also may synchronize the output of frame and/or sub-frame data in accordance with external color switch signal(s).

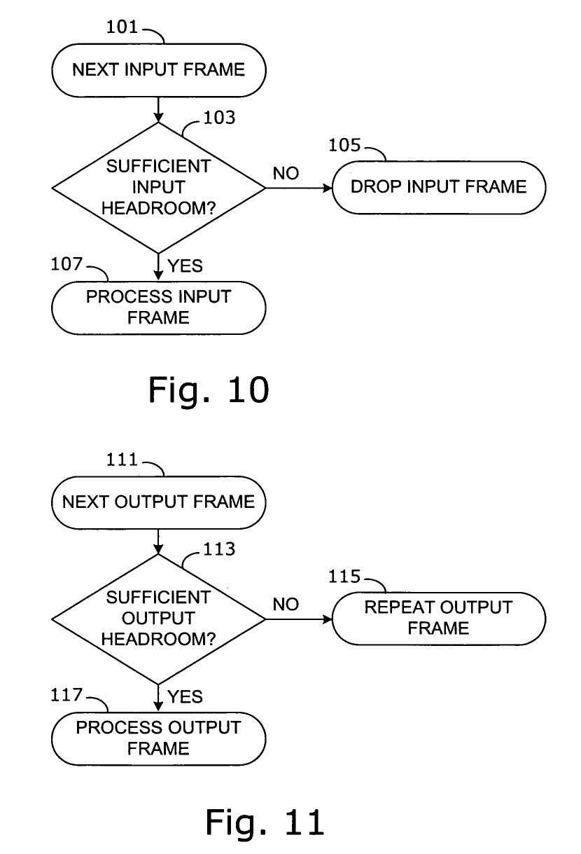

With reference to FIG. 10, a non-limiting example method of operation according to some embodiments of the invention may include receiving a next input frame (at block 101) and determining if sufficient input headroom is available to input the frame data (at block 103). If sufficient input headroom is not available, an input frame is dropped (at block 105). For example, the current input frame may be ignored (e.g. dropping the current input frame) or a previous input frame may be overwritten (e.g. dropping a previous input frame). In some implementations, at input frame changes, a check may be made that the oldest frame (e.g. the frame about to be overwritten) in the buffer (N−2) has already started to be output, and, if not, the previously input frame (N−1) may be overwritten instead (e.g. dropped). If sufficient input headroom is available, the method continues in processing the input frame (at block 107).

With reference to FIG. 11, another non-limiting example method of operation according to some embodiments of the invention may include beginning with a next output frame (at block 111) and determining if sufficient output headroom is available to output the frame data (at block 113). If sufficient output headroom is not available, an output frame is repeated (at block 115). For example, the current output frame may be repeated or another output frame may be repeated (e.g. from a previous output frame). In some implementations, at output frame changes, a check may be made that the frame to be output is sufficiently loaded into the buffer, and, if not, the prior output frame is output again (e.g. repeated). If sufficient output headroom is available, the method continues in processing the output frame (at block 117).

In some embodiments, the method(s) may include synchronizing the output of data to an external timing signal, as described above, prior to processing the next input and/or output frame. The foregoing elements do not necessarily have to be performed in the precise order described above. For example, in some embodiments the output headroom/repeat operation may be performed before the input headroom/drop operation. The foregoing examples of FIG. 10 and FIG. 11 may act independently, and one or the other may be omitted in some applications.

For example, before data is pre-fetched into the display output FIFOs to start a new frame, the data flow controller may check that sufficient data has been input to the frame such that the frame will be complete before the data output catches up to the data input. If not, then the data flow controller may reset various registers to repeat the output of the current frame. Before starting a new input frame, if the data flow controller estimates that the display input controller may overwrite previous frame data before output begins, the controller may instead overwrite the frame just completed.

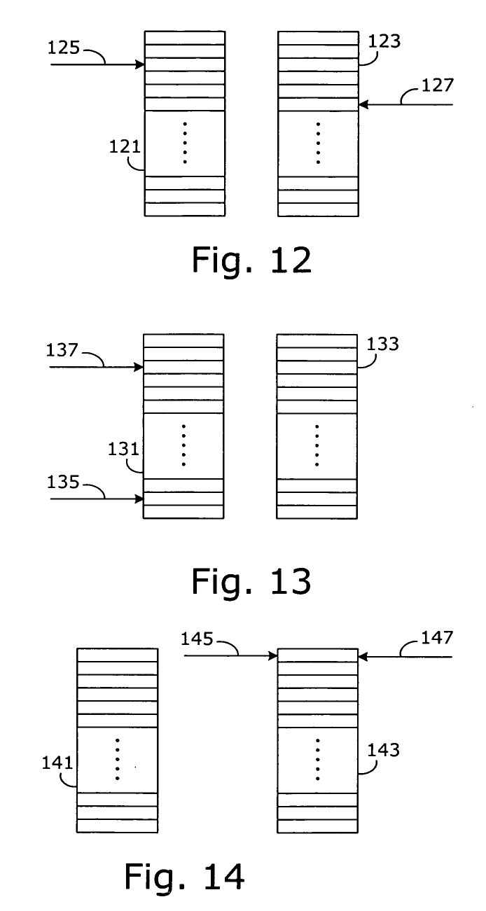

With reference to FIG. 12, the illustrated diagram shows an example of how the sub-frame memory space might look for a snapshot in time. For example, two sub-frame buffers 121 and 123 may exist in memory for each color (e.g. as separate memory devices or simply as logical or virtual portions of the same memory device). In a frame-synchronized implementation, during each frame, one sub-frame is output from one memory buffer, the other sub-frame is input to the other memory buffer. The output sub-frame is generally one frame delay behind the input sub-frame. In other words, if the input sub-frame is derived from input frame ‘N’, the output sub-frame is derived from input frame ‘N−1’. Each sub-frame space within memory may have two respective pointers 125 and 127 (amongst others). For example, one pointer 125 may denote the current write location for the next line of input video data, and the other pointer 127 may denote the current read position for the next line of output video data. At the end of each frame, the pointers ‘reset’ to the top of the opposite memory buffer. In other words, at each frame boundary, the input sub-frame buffer becomes the output sub-frame buffer, and vice-versa.

However, if the input and output video data streams are not frame-synchronized, then the pointers may be reset to the top of the buffers independently. For example, the output read pointer 127 may reset at each boundary determined by an external frame sync signal, and the input write pointer 125 may reset at each input frame boundary. This means that both pointers may move independently, and may both point to the same buffer at the same time.

Eventually, one pointer may catch up with another, and frame corruption may occur. With reference to FIG. 13, the illustrated diagram shows a pair of shared buffers 131 and 133 the output read pointer 137 catching up to the input write pointer 135. For example, this may occur if the external frame sync signal is faster than the input frame sync signal. For example, the read pointer 137 may have finished with sub-frame buffer ‘Y’ (corresponding to frame N−1), and reset to the top of sub-frame buffer ‘X’ (corresponding to frame N) before the write pointer 135 reached the end of sub-frame ‘X’.

In some embodiments configured for buffered video data flow, the read pointer may increment faster than the write pointer, for example, if sub-frames are output in one fifth (⅕) of the overall frame time. Accordingly, the read pointer may, from time to time, catch the write pointer, if the write pointer is not sufficiently close to the end of the buffer.

According to some embodiments of the invention, when the read pointer 137 reached the end of sub-frame buffer ‘Y’, the position of the write pointer 135 is checked. If it is determined that the write pointer 135 may not be far enough down sub-frame buffer ‘X’ (e.g. to avoid being caught), the read pointer 137 may be reset to the top of sub-frame buffer ‘Y’ again. This would have the effect of sending the sub-frame data of buffer ‘Y’ (from frame N−1) to the output again. For example, this method of operation may correspond to the ‘repeat’ in the drop/repeat algorithm, in some embodiments. Advantageously, in this example, even if the write pointer 135 may be reset to the top of buffer ‘Y’ before the read pointer 137 reaches the end of buffer ‘Y’, the read and write pointers cannot overlap, because the write pointer 135 increments slower than the read pointer 137.

Conversely, in some embodiments of the invention, the external frame sync signal may be slower than the input frame sync signal. Eventually, a situation may arise where the write pointer would catch up with the read pointer. However, since the read pointer increments faster, the only place the write pointer can catch the read pointer is after a reset to the top of a buffer. FIG. 14 illustrates a pair of shared buffers 141 and 143 with both a write pointer 145 and a read pointer 147 at the beginning of the buffer 143. For example, this may occur if the vertical blanking period for the output is much longer than that for the input. The read pointer 147 may be reset to the top of a buffer, but the write pointer 145 may also reset to the top of the same buffer, and start writing before the read pointer begins a new sub-frame.

According to some embodiments of the invention, when the write pointer 145 reaches the end of a buffer ‘X’, the position of the read pointer 147 is checked to determine if the read pointer 147 is reset to the top of the buffer ‘Y’, but had not yet started to read out the data. If so, the write pointer 145 may be reset back to the top of the same buffer ‘X’, and may overwrite the frame data just input. For example, this method of operation may correspond to the ‘drop’ in the drop/repeat algorithm.

An example algorithm for implementing the full drop/repeat functionality may be summarized as follows:

REPEAT: If the read pointer is to be reset to the top of buffer ‘X’, but the write pointer is currently pointing to a location in buffer ‘X’ that is not sufficiently deep (or is reset to the top of buffer ‘X’), then the read pointer should be reset to the top of buffer ‘Y’, instead. The distance into the buffer to which the write pointer should be set can be estimated by the differential in FIFO fill/empty speeds. For example, if the input FIFOs are filled at 10 MHz, and the output FIFOs are emptied at 50 MHz, the write pointer should be set at greater than about ⅘ through the buffer.

DROP: If the write pointer is to be reset to the top of buffer ‘X’, but the read pointer is currently reset to the top of buffer ‘X’ (awaiting the end of the output vertical blanking period), then the write pointer should be reset to the top of buffer ‘Y’, instead.

Note that special consideration may be given to a situation where both pointers are to be reset substantially simultaneously. For example, the implementation may ensure that the flow control algorithm either checks and resets the pointers sequentially, or detects and deals with this case in some other manner.

The foregoing and other aspects of the invention are achieved individually and in combination. The invention should not be construed as requiring two or more of such aspects unless expressly required by a particular claim. Moreover, while the invention has been described in connection with what is presently considered to be the preferred examples, it is to be understood that the invention is not limited to the disclosed examples, but on the contrary, is intended to cover various modifications and equivalent arrangements included within the spirit and the scope of the invention.

What is claimed is:

1. An apparatus, comprising:
an input portion adapted to receive input data for a light modulator;
an output portion adapted to output data to the light modulator; and
a flow controller coupled to the input portion and the output portion,
wherein the flow controller is configured to control the flow of data from the input portion to the output portion, and
wherein the flow controller is configured to control the output portion to output data to the light modulator in accordance with a timing signal which is independent of the input data.

2. The apparatus of claim 1, wherein the independent timing signal is to be provided from a color switching device.

3. The apparatus of claim 1, wherein the independent timing signal is to be provided in accordance with a timing mark on a rotating color wheel.

4. The apparatus of claim 1, further comprising a converter portion coupled between the input portion and the output portion, the converter portion being adapted to process the input data and provide the output data in a format suitable for the light modulator.

5. The apparatus of claim 4, further comprising a memory interface coupled between the converter and the output portion.

6. The apparatus of claim 1, further comprising a memory coupled to the flow controller, wherein the flow controller is adapted to perform at least one of dropping input data or repeating output data in accordance with a usage of the memory.

7. The apparatus of claim 1, further comprising at least a first data buffer and a second data buffer coupled to the flow controller, wherein the flow controller is adapted to perform at least one of dropping input data or repeating output data in accordance with a status of the buffers.

8. A method, comprising:
receiving input data for a light modulator;
receiving a timing signal which is independent of the input data; and
outputting data to the light modulator in accordance with the independent timing signal.

9. The method of claim 8, further comprising:
providing the independent timing signal from a color switching device.

10. The method of claim 8, further comprising:
providing the independent timing signal in accordance with a timing mark on a rotating color wheel.

11. The method of claim 8, further comprising:
providing at least a first and second buffer for buffering the input data and the output data; and
dropping new input data in accordance with a status of at least one of the first and second buffers.

12. The method of claim 11, further comprising:
determining whether receiving the new input data might overwrite output data in at least one of the first and second buffers.

13. The method of claim 8, further comprising:
providing at least a first and second buffer for buffering the input data and the output data; and
repeating output data in accordance with a status of at least one of the first and second buffers.

14. The method of claim 13, further comprising:
determining whether outputting new output data might overtake new input data in at least one of the first and second buffers.

15. A system, comprising:
a light modulator; and
a controller coupled to the light modulator and adapted to receive input data and provide output data to the light modulator,
wherein the controller is configured to provide the output data to the light modulator in accordance with a timing signal which is independent of the input data.

16. The system of claim 15, further comprising:
a light engine positioned to direct light onto the light modulator, the light engine including a color switching device configured to switch a color of the light on the light modulator,
wherein the independent timing signal is provided from the color switching device.

17. The system of claim 15, further comprising:
a light engine positioned to direct light onto the light modulator, the light engine including a rotating color wheel configured to switch a color of the light on the light modulator,
wherein the independent timing signal is provided in accordance with a timing mark on the rotating color wheel.

18. The system of claim 15, wherein the controller comprises a memory interface providing an interface to a memory, wherein the controller is adapted to perform at least one of dropping input data or repeating output data in accordance with a usage of the memory.

19. The system of claim 15, wherein the controller comprises:
at least a first and a second data buffer; and
a flow controller coupled to the first and second buffers,
wherein the flow controller is adapted to perform at least one of dropping input data or repeating output data in accordance with a status of the buffers.

20. The system of claim 19, wherein the flow controller is adapted to determine whether receiving new input data might overwrite output data in at least one of the first and second buffers.

21. The system of claim 19, wherein the flow controller is adapted to determine whether outputting new output data might overtake new input data in at least one of the first and second buffers.
